(19) United States
(12) Patent Application Publication
(10) Pub. No.: US 2006/0146758 A1
(43) Pub. Date: Jul. 6, 2006

(54) Method to facilitate dynamic allocation of spreading code resources

(76) Inventors: John M. Harris, Chicago, IL (US); Hao Bi, Lake Zurich, IL (US); Colin D. Frank, Park Ridge, IL (US); Wang Fan, Vernon Hills, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/026,914

(22) Filed: Dec. 30, 2004

(51) Int. Cl. H04B 7/216

(52) U.S. Cl. 370/335

(57) ABSTRACT

A communication system having spreading code resources (11) (such as, for example, Walsh codes), and upon providing (12) an initial quantity of those spreading code resources to support a voice communication by a given mobile station, then determines (13) whether to alter that initial allocation during that voice communication. For example, when the voice communication for this mobile station does not actively comprise speech, a determination can be made to allocate a reduced allotment of the spreading code resources. The system then switches (14) the new allocation of spreading code resources for the initial allocation and the mobile station continues its voice communication using the new (increased or decreased) quantity of spreading code resources.

### TECHNICAL FIELD

This invention relates generally to communications and more particularly to the allocation and use of spreading code resources during the facilitation and support of such communications.

### BACKGROUND

Communication systems of various kinds are known. In essentially all communication systems one or more resources are allocated to facilitate the communication needs of a given individual user or user group. For example, in essentially all communication systems bandwidth comprises such a shared resource. In some systems bandwidth is allocated specifically through assignment of a given carrier frequency (or carrier frequency pair) as characterizes frequency division multiplexed communications. In other systems (or in combination with a frequency divided approach as just mentioned) the communication resource may be parsed with respect to time as characterizes a time divided approach (such as time division multiplexed and time division multiple access approaches).

Regardless of the particular resource involved, careful management of the resource allocation process becomes increasingly important as the user base grows. Efficient resource management tends to permit an increased number of users. Conversely, inefficient resource management can have the opposing effect.

So it is with spreading code resources as are used in code division multiple access (CDMA) systems (at least from the perspective of the forward link). The use of spreading codes and corresponding allocation of such codes with respect to a given user population can achieve considerable loading improvements as compared to numerous competing technologies. Notwithstanding these improvements, however, at some point, loading for a given system can increase to the point where inefficient allocation practices can again pose a barrier to further expansion of the user population.

To illustrate, most CDMA communication systems that use orthogonal spreading codes, such as Walsh codes, have only a limited number of such codes available for allocation in the forward link. At least some fielded systems using Walsh codes are only capable of supporting around 28 active voice call per sector (presuming support of RC3 (radio configuration 3), with approximately double that code capacity being possible when using RC4). Absolute limitations on the available number of Walsh codes contribute to this situation. Limitations on the available number of Walsh codes becomes more of a bottleneck with the availability and use of smart/fixed/diverse antennas, hybrid-automatic request (HARQ) techniques, non-uniformly loaded systems, low bit rate vocoders and services, and the like. For example, a given user will hold a given Walsh code allocation for the entire duration of their call. Depending upon the nature of the call, this can represent a squandering of upwards of 80 percent of the allocated Walsh code resource capacity while establishing the call and upwards of 60 percent of the corresponding throughput capacity during the course of the call itself.

As a net result, existing code division multiplex systems such as CDMA2000 and EVDV, though highly efficient as compared to numerous other competing technologies, can nevertheless be viewed, the inventors have discovered, as being themselves relatively wasteful of an important system resource; their spreading codes and the communication capacity as corresponds thereto.

### BRIEF DESCRIPTION OF THE DRAWINGS

The above needs are at least partially met through provision of the method to facilitate dynamic allocation of spreading code resources described in the following detailed description, particularly when studied in conjunction with the drawings wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figure are illustrated for simplicity and clarity. Common but well-understood elements or steps that are useful or necessary in a commercially feasible embodiment are not necessarily depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, the quantity of spreading code resources as are allocated to support a given communication are switched as between at least a first and a second quantity of spreading code resources. In a preferred approach this switching is based, at least in part, on voice activities as characterize the communication itself.

For example, so configured, the quantity of spreading code resources as are allocated in support of a given communication can be dynamically reduced. This, in turn, effectively frees up at least some spreading code resources that can then be allocated to support other communications, hence effectively increasing the capacity of the overall system to support the communication needs of multiple simultaneous users.

Pursuant to some approaches, this dynamic shift with respect to a quantity of spreading code resources can comprise, for example, shifting from a shared spreading code resource to an unshared dedicated spreading code resource, or vice versa.

A determination to effect such a switch can be based upon any of a wide variety of triggering criteria. For example, such a determination may be based upon determining when a given user is not presently sourcing a voice communication comprising speech (or, conversely, when such a user is presently sourcing a voice communication that comprises speech). As another example, such a determination may be based upon a prediction, calculation, or the like that tends to indicate that the user will (or will not) be providing (or not providing) speech-based communications in the near future.

Via these teachings a given number of spreading code resources as are otherwise available for allocation can be dynamically allocated in a manner that both assures acceptable quality of service for at least a majority of users while simultaneously permitting an increase in the number of users (and/or in the bandwidth provided to a given set of users) that a given system can support.

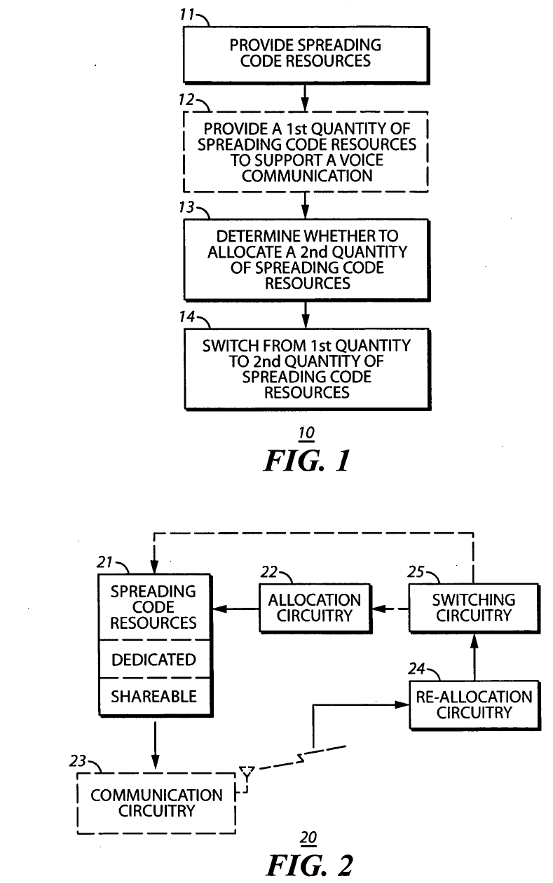

These and other benefits may become more evident upon making a thorough review and study of the following detailed description. Referring now to the drawings, and in particular to FIG. 1, a corresponding process 10 will typically begin with the provision 11 of a plurality of spreading code resources such as, but not limited to, Walsh codes. In a preferred approach such spreading code resources will include resources both to be shared and to be used in an unshared manner. Such usage categories can be static or dynamically determined as appropriate to meet the needs of a given implementation. It will also be understood that such spreading code resources are typically parseable into smaller spreading code resources and that, so characterized, will support greater or lesser bandwidth payloads depending upon how and whether such spreading code resources are parsed or subdivided in a given instance. Such spreading code attributes are well understood in the art and further elaboration will not be presented here for the sake of brevity.

A particular quantity of these spreading code resources (denoted here for purposes of illustration as a first quantity of spreading code resources) are provided 12 to support a given voice communication. This allocation can be as per essentially any initial allocation scheme including allocation schemes as are presently known in the art and likely including hereafter developed allocation schemes.

In a typical illustrative example, such an initial allocation of spreading code resources in support of a voice communication will likely comprise allocation of a particular quantity (such as one or more) of unshared or otherwise dedicated Walsh codes. This allocation will typically comprise some usually predetermined quantity of capacity as will likely (or assuredly) support the voice communication with at least a predetermined level of quality of service. In a typical initial allocation scheme, this level of quality will usually comprise a high, or a highest, level of quality of service and hence will usually represent a large or maximum capacity and/or bandwidth allocation (at least as corresponds to Walsh code allotment).

This process 10 then effects a determination 13 regarding whether to allocate a second quantity of spreading code resources in support of this same voice communication. For example, in a preferred approach, this determination 13 comprises determining whether to allocate a reduced quantity of spreading code resources as compared to an initial large or maximum allocation of spreading code resources. These teachings also contemplate, however, determining whether to allocate an increased quantity of spreading code resources in a given instance (as may be appropriate, for example, when a relatively small initial allotment has been and/or when a presently allocated quantity of spreading code resources is, for whatever reason, presently less than a potential maximum).

As a simple illustration, when the first quantity of allocated spreading code resources comprises allocation of at least one unshared spreading code, this determination 13 can comprise a determination regarding whether to allocate one or more shared spreading codes (either in addition to or in lieu of the initial allocation of one or more unshared spreading codes). As another simple illustration, when the first quantity of allocated spreading code resources comprises allocation of a certain number of shared spreading codes, this determination 13 can comprise a determination regarding whether to allocate additional shared spreading codes or to reduce the present allotment of shared spreading codes to thereby either increase or decrease the corresponding throughput capacity as corresponds to such spreading code resources.

This determination can be based on any number of relevant criteria. As one example, determining whether to allocate a second quantity of spreading code resources in lieu of a previously allocated quantity of spreading code resources can be based, at least in part, upon determining whether the voice communication presently does not substantially comprise speech (or, conversely, that the voice communication does presently substantially comprise speech). In particular, many voice communications include at differing times speech content as sourced by a given transmitting party and silence or background noise as occurs when that party is silent in order to listen to another party speak, to gather their thoughts, or for any number of other reasons that tend to characterize ordinary human speech patterns and behaviors.

Simply put, a decision can be made to dynamically increase (or maintain) a quantity of spreading code resources when speech is presently occurring. This, in turn, tends to assure that the quality of the speech will be of good quality. Conversely, a decision can be made to decrease the quantity of spreading code resources that are dedicated to a given voice communication in the absence of actual speech. Though decreasing the spreading code resources concurrently reduces the ability of the system to accurately render the non-speech portions of a voice communication, such reduction in quality will typically not be particularly noticeable to system users as the non-speech portions are typically not conveying linguistic content that requires recognition and mental processing on the part of the recipient.

Such a decision criteria can be informed through various means. For example, a characterizing code can be developed by a speech vocoder upon recognizing the absence of speech input, and that code can be transmitted for reception by the system infrastructure. That code, in turn, can form the basis (or a basis) of determining the present absence of speech content in a voice communication. In a similar manner a different characterizing code can be used to identify a given packet as containing speech content.

As another approach (or as used in combination with the above), such a determination can be based upon a determination regarding a likelihood that a given voice communication presently, or in the near future, will or will not substantially comprise speech. As one illustrative example, determining that a given mobile station is presently receiving (as versus sourcing) a speech communication can serve to aid a determination that this same mobile station is not (or will not in the near future) be itself transmitting speech content. This in turn will permit a determination as described above to effectively dynamically reduce a presently allocated quantity of spreading code resources in recognition of this situation and likely corresponding condition.

Upon determining that such a change to the allocation of spreading code resources should be effected, this process 10 then promotes switching 14 from that first quantity of spreading code resources to a second quantity of spreading code resources. In a preferred approach, this switch comprises a dynamic alteration to the spreading code resources that are allocated for use by a mobile unit during a given voice communication wherein, of course, the second quantity is different as compared to the first quantity. This switch can be effected in various ways as may best suit the needs and/or capabilities of a given system.

As but one example, such a switch may be effected, at least in part, by transmission of a corresponding reallocation message to the impacted mobile station. Such a reallocation message may be preceded, if desired, by transmission of information to the mobile station regarding at least one candidate spreading code resource (which may comprise, for example, either the resource information itself or a pointer that identifies such a resource). In such a case, the reallocation message itself may contain content that essentially prompts reliance by the mobile station on the candidate spreading code resource information. So configured, for example, a mobile station may be primed or pre-loaded with certain spreading code information. Then, if and when the mobile station is to switch to use of such pre-loaded spreading code information, a simple and short code can be used to permit a very rapid switch to use of the revised spreading code allocation. This, in turn, can aid in permitting speedy switching from one quantity of spreading code resources to another, thereby better facilitating the intent and value of these teachings in at least some application settings.

Pursuant to one approach, such a voice user can be provided with a dedicated power control sub-channel. In the alternative (or in combination therewith, if desired), the voice user can make use of punctured power control information on a specific shared bearer/target channel using, for example, prior art methods that are employed to puncture power control on a fundamental channel. In such a case, it may be useful, upon channel signing or the handing off of such a voice user, to specifically inform that voice user as to which Walsh code will carry the relevant power control information.

When employing such an approach, of course, there exists the possibility that an insufficient quantity of spreading code resources may be presently available upon determining a need to switch a given mobile station to an increased number of spreading code resources. In such a case, the existing call mobile station can be assigned priority relative to new call requests and therefore contend more rapidly for the increased spreading code allocation. In addition, or in the alternative, the non-silent audio can be queued with playback being initiated once the mobile station has achieved the desired increased spreading code allocation. Other techniques could be employed as appropriate to the needs or capabilities of a given system. For example, the audio information could be sped up and/or the silent intervals shrunken to aid in reducing or eliminating such an audio delay or buffering.

There also exists a possibility that a given mobile station will not receive pointer information intended to redirect that mobile station to a particular allocation of spreading code resources. For example, a mobile station might fail to receive a message or indicator specifying use of a normal or an eighth rate mode. By one approach, the network can persist in rebroadcasting such information on some regular (such as every 40 milliseconds) or irregular basis until the mobile station acknowledges reception of this pointer information. As a related alternative approach, the network could repeat transmission of this information by some longer period of time (such as 40 milliseconds) following an initial transmission, followed by subsequent repetitions using a different period of time, such as a shorter duration of time (for example, 20 milliseconds). This approach may allow the mobile station to make a transition to the signaled channel prior to complete effectation of the process.

It may also be desirable to make modified accommodation of handoff procedures when employing these teachings. When a handoff occurs at a time when a mobile station is using a normal mode or a normal allotment of spreading code resources during a voice communication, the handoff message can likely be supported using prior art methods and techniques. In a code division multiple access system, however, and when a handoff needs to occur at a time when a mobile station is using, for example, the above-described eighth rate mode, the mobile station will preferably transition to the normal mode before carrying out the handoff direction message. This transition can be facilitated using the spreading code resource allocation switching concepts set forth herein. If desired, this reallocation of spreading code resources can be accompanied by a heightened priority in favor of the mobile station undergoing a handoff into order to aid in mitigating any undue delay and associated degradation of quality of service. Or, in the alternative, one could transmit a handoff direction message in a pointer style format over the eighth rate frame (or via the otherwise reduced spreading code allocation).

These essential teachings can be embodied, realized, and/or exploited in a wide variety of ways. Some illustrative examples will now be provided.

### EXAMPLE 1

Voice activity detection can drive a dynamic selection of (and switching between) two discrete modes such as a so-called normal mode and an eighth rate mode. In the normal mode a mobile station can utilize normal rate detection as per prior art practice to facilitate detection of full, half, quarter, and eighth rate frames. The eighth rate mode, on the other hand, can be limited to only the eighth rate mode. When stipulating required use of the eighth rate mode (during, for example, non-speech portions of a voice communication) approximately 80 percent of the capacity ordinarily associated with a full complement of Walsh codes is shed and rendered at least temporarily available for use by other network elements.

To illustrate, approximately five eighth rate frame users can share one 64-bit or 128-bit Walsh code with a throughput of roughly 9 Kbps, wherein it is noted that such sharing can be effected by interleaving their coded frames or bits on a shared fundamental channel (where interleaving the coded bits thereby preserves or gains some time diversity benefits), by using approximately four millisecond timeslots, or such other approach as may be appropriate for use in a given context. When interleaving coded bits in this manner, it may also be useful to differently set the power of each such bit to correspond to the power requirements of each individual mobile station. Accordingly, adjacent interleaved bits may, if desired, vary with respect to their own corresponding power setting.

In addition, in a preferred configuration, the mobile station will be capable of receiving both dim and burst pointer information in either the normal mode or the eighth rate mode.

### EXAMPLE 2

Similar benefits and results are attainable using a very long Walsh code with low bit rate (having, for example, a length of approximately 8*64 or 8*128, and a throughput of roughly 1.5 Kbps) when the speaker is operating in this so-called eighth rate mode.

The general approach set forth, when interleaving vocoded frames, has the potential benefit of avoiding a need for creating a new eighth rate mode channel as tends to characterize the second example presented above. This is particularly so when deployed in conjunction with a system that makes provision for a shared FCH (fundamental channel). In such a system, when a mobile station's voice call is otherwise in what amounts to an eighth rate mode, that call can be assigned to the shared fundamental channel. A full rate frame can then be sent on this shared fundamental channel on some incremental basis, such as one out of every X frames.

Those skilled in the art will appreciate that these teachings can be implemented in various ways and are compatible for use with a wide variety of platforms. As a general illustration of this point, and referring now to FIG. 2, an implementing apparatus 20 having allocation access to a quantity of spreading code resources 21 comprising both dedicated spreading codes and shareable spreading codes will typically comprise allocation circuitry configured and arranged to support the allocation of a first quantity of spreading code resources (such as a particular non-zero quantity of dedicated spreading codes) to support at least one communication of a given communication unit 23. Re-allocation circuitry responsive to the nature of the communications of that communication unit 23, and particularly to the voice activities thereof as described above, is then preferable configured and arranged to determine whether to allocate a second quantity of spreading code resources (such as a non-zero quantity of shared spreading codes) in lieu of the previously allocated first quantity of spreading code resources.

Switching circuitry 25, responsive to the re-allocation circuitry 24, is then configured and adapted to effect switching from the first quantity of spreading code resources to the second quantity of spreading code resources as determined by the re-allocation circuitry 24. (As used herein, those skilled in the art will appreciate that “circuitry” can refer to dedicated fixed-purpose circuits and/or partially or wholly programmable platforms of various types and that these teachings are compatible for realization via any such modes of deployment.)

Those skilled in the art will understand and appreciate that the specifics regarding such elements and their interaction as described will be dictated by the needs, capabilities, and/or limitations of a given application setting. In many cases a single programmable platform as already services a part of the resource allocation functionality of a given network may likely be programmed to effect the various above-described elements and/or steps.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing spreading code resources comprising at least some dedicated spreading codes and some shareable spreading codes;
determining whether to allocate a second quantity of spreading code resources wherein the second quantity of spreading code resources comprises a quantity of shared spreading codes;
switching from a first quantity of spreading code resources, wherein the first quantity of spreading code resources comprises a quantity of dedicated spreading codes, to the second quantity of spreading code resources during a voice communication based on voice activities wherein the second quantity of spreading code resources comprises a different quantity of spreading code resources as compared to the first quantity of spreading code resources.

2. The method of claim 1 wherein determining whether to allocate a second quantity of spreading code resources further comprises determining whether to allocate a reduced quantity of spreading code resources as compared to the first quantity of spreading code resources.

3. The method of claim 1 wherein determining whether to allocate a second quantity of spreading code resources further comprises determining whether to allocate an increased quantity of spreading code resources as compared to the first quantity of spreading code resources.

4. The method of claim 1 wherein the first quantity of spreading code resources further comprises a first quantity of unshared spreading code resources that represent a first quantity of capacity.

5. The method of claim 1 wherein determining whether to allocate a second quantity of spreading code resources further comprises determining whether to allocate a second quantity of shared spreading code resources that represent a second quantity of capacity, which second quantity of capacity is different than the first quantity of capacity.

6. The method of claim 5 wherein determining whether to allocate a second quantity of spreading code resources further comprises determining which voice user on that first quantity of shared spreading code resources has a highest level of voice activity.

7. The method of claim 1 wherein switching from a first quantity of spreading code resources to the second quantity of spreading code resources further comprises providing a reallocation message to a mobile station.

8. The method of claim 7 and further comprising:
providing, prior to providing the reallocation message, information regarding at least one candidate spreading code resource to the mobile station.

9. The method of claim 8 wherein providing a reallocation message to the mobile station further comprises providing a reallocation message that requires reliance by the mobile station on the information regarding at least one candidate spreading code resource.

10. The method of claim 1 wherein determining whether to allocate a second quantity of spreading code resources further comprises determining whether to allocate a second quantity of spreading code resources as a function, at least in part, of determining that the voice communication presently does not substantially comprise speech.

11. The method of claim 1 wherein determining whether to allocate a second quantity of spreading code resources further comprises determining whether to allocate a second quantity of spreading code resources as a function, at least in part, of determining that the voice communication presently substantially comprises speech.

12. The method of claim 1 wherein determining whether to allocate a second quantity of spreading code resources further comprises determining whether to allocate a second quantity of spreading code resources as a function, at least in part, of determining that the voice communication is presently likely to not substantially comprise speech.

13. The method of claim 12 wherein determining whether to allocate a second quantity of spreading code resources as a function, at least in part, of determining that the voice communication is presently likely to not substantially comprise speech further comprises determining whether the mobile station is presently receiving a speech communication.

14. The method of claim 1 wherein determining whether to allocate a second quantity of spreading code resources further comprises determining whether to allocate a second quantity of spreading code resources as a function, at least in part, of determining that the voice communication is presently likely to substantially comprise speech.

15. An apparatus having access to a quantity of spreading codes resources comprising at least some dedicated spreading codes and at least some shareable spreading codes, comprising:
allocation circuitry to allocate a first quantity of spreading code resources to support at least one communication of a communication unit, wherein the first quantity of spreading code resources comprises a non-zero quantity of dedicated spreading codes;
re-allocation circuitry responsive to voice activities as comprise a part of the at least one communication to determine whether to allocate a second quantity of spreading of spreading code resources to support the at least one communication of the communication unit in place of the first quantity of spreading code resources, wherein the second quantity of spreading code resources comprises a non-zero quantity of shared spreading codes and further comprises a different quantity of spreading code resources as compared to the first quantity of spreading code resources;
switching circuitry responsive to the re-allocation circuitry to effect a switch from the first quantity of spreading code resources to the second quantity of spreading code resources.

16. The apparatus of claim 15 wherein the re-allocation circuitry comprises means for determining whether to allocate the second quantity of spreading code resources.

17. The apparatus of claim 16 wherein the means for determining is responsive to the voice activities.

18. The apparatus of claim 15 wherein the second quantity of spreading code resources comprises a reduced quantity of spread code resources as compared to the first quantity of spreading code resources.
